(19) United States
(12) Patent Application Publication
(10) Pub. No.: US 2026/0165911 A1
(43) Pub. Date: Jun. 18, 2026

(54) Handheld Massager

(71) Applicant: James W. Richter, Marina del Rey, CA (US)

(72) Inventor: James W. Richter, Marina del Rey, CA (US)

(21) Appl. No.: 18/984,582

(22) Filed: Dec. 17, 2024

(51) Int. Cl. A61H 39/04; A63B 23/16

(52) U.S. Cl. CPC A61H 39/04; A63B 23/16; A61H 2201/0153

(57) ABSTRACT

A handheld massager comprising: a massager portion having a first arm and a second arm that curve toward one another and terminate at distal ends configured to be moved relative to one another to massage a tissue; and a handle portion coupled to the massager portion, the handle portion having a first leg and a second leg configured to be moved relative to one another to move the distal ends.

### FIELD

An aspect of the disclosure is directed to a device that alleviates tension in the body, particularly the soft tissues of the hands and wrists. Other aspects are also described and claimed.

### BACKGROUND

The rise of smartphones, which are not typically designed to be ergonomically conducive to the human hand, has contributed significantly to hand and wrist pain. Whether from cell phone use or some other activity or environmental factor(s), many people deal with muscle tightness, tendon soreness and other physical ailments, particularly in the hands and wrists due to repetitive stress and overuse.

### SUMMARY

An aspect of the disclosure is directed to a handheld stress-relief device that may be squeezed and/or applied anywhere on the body to provide relief, but particularly the soft tissues of the hands and wrists. Representatively, the device may provide myofascial release in the hands, wrists, and other body parts, which can alleviate pain, improve recovery and prevent future injury. The device may include two “legs,” above which are two “arms.” When the legs are squeezed, the arms come together, applying pressure on the body part that has been inserted between the arms. Squeezing the legs also allows users to build hand strength and improve blood flow throughout their upper extremities, further supporting their health. Inserting fingers between the arms, the user can pull the legs up and back to stretch the soft tissues of the fingers, hand, wrist and arm. In addition, there are many well-documented “pressure points” in the hands, which this device can activate. For example, when this device is applied to one's pressure point in the Thenar pad, also known as the “hand valley point,” some have found that it alleviates discomfort from stress, migraines, toothaches, shoulder tension and neck pain. This device can help users activate pressure points and tight muscles around the hands, wrists and other parts of the body without straining their hands.

In some aspects, the device may include an aluminum skeleton within a silicone encasement. There may be a screw or pin that holds the skeleton together. A small amount of lubricant, such as grease, may be applied to the joint to allow for smooth movement of the device. Other rigid materials could be used for the skeleton, and other materials could be used for the encasement. In some aspects, the silicone encasement may provide the device with round or smooth sides or edges, but the device could take on other dimensions that don't distort its basic function. For example, in some aspects the arms and legs could be more angular. In still further aspects, the device may also include a wide enough base at the bottom of the legs so as to support the device when it is stood upright on a surface, such as the user's desk or work bench. This ability to “stand up” keeps it in view of the user and makes it easier to pick up.

Representatively, in some aspects, the disclosure is directed to a handheld massager including a massager portion having a first arm and a second arm that curve toward one another and terminate at distal ends configured to be moved relative to one another to massage a tissue; and a handle portion coupled to the massager portion, the handle portion having a first leg and a second leg configured to be moved relative to one another to move the distal ends. In some aspects, the first arm and the second arm further comprise proximal ends that curve inwardly toward one another to form a c-shaped massager portion. In still further aspects, the proximal ends are coupled to the handle portion. Still further, the distal ends are separated by a gap for receiving the tissue. In some aspects, the distal ends have a substantially round shape. In still further aspects, the first leg and the second leg have proximal ends coupled to the massager portion and distal ends that are wider than the proximal ends. In other aspects, the distal ends are flat and coplanar such that they are operable to support the massager in an upright position. In some aspects, a movement of the first leg and the second leg toward one another causes the distal ends to move toward one another and massage the tissue. In other aspects, the first leg and the second leg are biased away from one another by a biasing material coupled to a joint between the first leg and the second leg. In still further aspects, a portion of the first arm is integrally formed with a portion of the first leg and a portion of the second arm is integrally formed with a portion of the second leg. In some aspects, an interior support member forms the first arm, the second arm, the first leg and the second leg, and the interior support member is molded within a silicone outer member.

In another aspect, the disclosure is directed to a method of manufacturing a handheld massager including providing a support member having a first member defining a first curved portion and a first elongated portion, a second member defining a second curved portion and a second elongated portion, and a joint movably connecting the first member to the second member; and molding a compliant material over the support member to form a handheld massager. In some aspects, providing the support member comprises milling the first member and the second member from a piece of aluminum. In other aspects, the first member and the second member are connected together by a fastener to form the joint that allows the first member and the second member to move relative to one another. In some aspects, a lubricant is applied to the joint. In some aspects, the first leg or the second leg comprise a recessed region dimensioned to grip the compliant material. In some aspects, molding comprises positioning the support member within an interior mold of cured compliant material. In other aspects, molding further comprises positioning the support member and interior mold within an exterior mold of the compliant material. In still further aspects, the compliant material is cured to form the massager. In some aspects, the compliant material may be a silicone material.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect in this disclosure are not necessarily to the same aspect, and they mean at least one.

FIG. 1 illustrates a perspective side view of one aspect of a handheld massager.

FIG. 2 illustrates a side perspective cutout view of another aspect of a handheld massager of FIG. 1.

FIG. 3 illustrates a side perspective cutout view of another aspect of the handheld massager of FIG. 1.

FIG. 4 illustrates a side perspective view of another aspect of the handheld massager of FIG. 1.

FIG. 5 illustrates a perspective view of another aspect of a handheld massager during use.

FIG. 6 illustrates a block diagram of one exemplary method of manufacturing a handheld massager.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

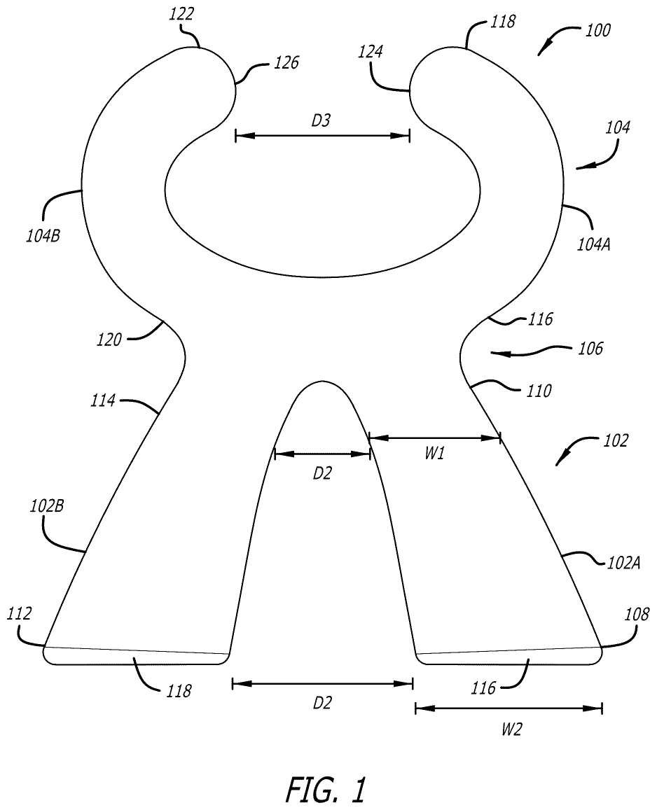

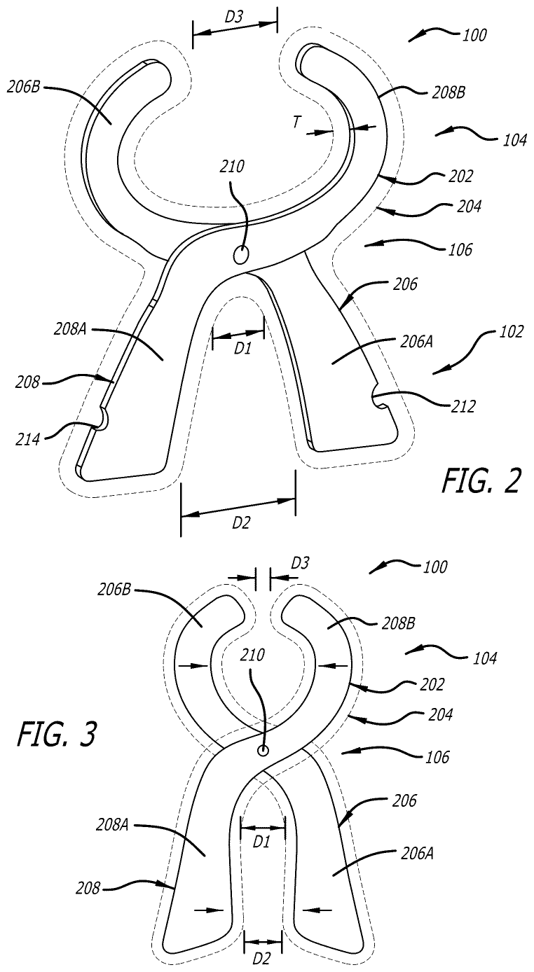

FIG. 1 illustrates a perspective side view of one aspect of a handheld massager device. Handheld massager device 100 includes a handle portion 102 and a massager portion 104. Handle portion 102 may be connected to massager portion 104 at a joint region 106 that allows handle portion 102 to move massager portion 104. Referring now to handle portion 102, handle portion 102 may include a first leg 102A and a second leg 102B. First leg 102A may have a proximal portion 110 and a distal portion 108. Similarly, second leg 102B may have a proximal portion 114 and a distal portion 112. The proximal portions 110, 114 may be connected at joint region 106 to massager portion 104. In some aspects, the proximal portions 110, 114 may be narrower than the distal portions 108, 112 of each of first and second legs 102A, 102B. For example, referring to first leg 102A, proximal portion 110 may have a width dimension (W1) that is smaller than a width dimension (W2) of distal portion 108 as shown. In addition, in the resting configuration shown in FIG. 1, first and second legs 102A, 102B may extend from joint 106 away from one another such that there may be a gap between legs 102A, 102B which increases towards the distal ends 108, 112. For example, a distance (D1) of the gap between proximal ends 110, 114 may increase to distance (D2) toward the distal ends 108, 112. Legs 102A, 102B may be biased to this resting position such that application of a force (e.g., squeezing force) is required to move legs 102A, 102B closer together, and when the force is removed, legs 102A, 102B move back to the position shown in FIG. 1. In addition, bottom sides 116, 118 of each of distal portions 108, 112 may be generally flat and coplanar with one another. In this aspect, device 100 may be supported or stand in an upright position as shown in FIG. 1 when bottom sides 116, 118 are placed on another flat surface. As will be described in more detail in reference to FIGS. 2-3, during operation, first and second arms 102A, 102B may be squeezed together by a user's hand to move massager portion 104 to a massaging position suitable for massaging tissue or a body portion (e.g., the user's other hand).

Referring now to massager portion 104, massager portion 104 may include a first arm 104A and a second arm 104B. First arm 104A may have a proximal portion 116 and a distal portion 118. Similarly, second arm 104B may have a proximal portion 120 and a distal portion 122. The proximal portions 116, 120 may be connected at joint region 106 to handle portion 102. Arms 104A, 104B may have a curved or bowed shape between the proximal portions 116, 120 and distal portions 118, 122 as shown. In this aspect, arms 104A, 104B may be considered to form a c-shaped massager portion 104. For example, arms 104A, 104B may curve outwardly then back inward toward one another at the proximal portions 116, 120 and distal portions 118, 122. Distal portions 118, 122 may terminate at interfacing distal ends 124 and 126 that are spaced a part from one another a distance (D3) suitable for receiving a tissue or body part to be massaged. For example, in the resting position as shown, distal ends 124, 126 may be spaced distance (D3) from one another. A tissue or body part may be positioned between distal ends 124, 126. Once the tissue or body part is between distal ends 124, 126, handle 102 may be squeezed to move distal ends 124, 126 to a massaging position (e.g., closer together) that applies pressure or otherwise massages the body part positioned between them. In some aspects, distal ends 124, 126 may have a rounded or curved shape as shown to maximize the contact between distal ends 124, 126 and the tissue or body part being massaged. Representatively, in some aspects, massager portion 104 (and handle portion 102) may be formed by a rigid interior support or frame member that is molded within an exterior compliant member that forms the rounded or curved distal ends 124, 126 as shown. These aspects will now be described in more detail in reference to FIGS. 2-3.

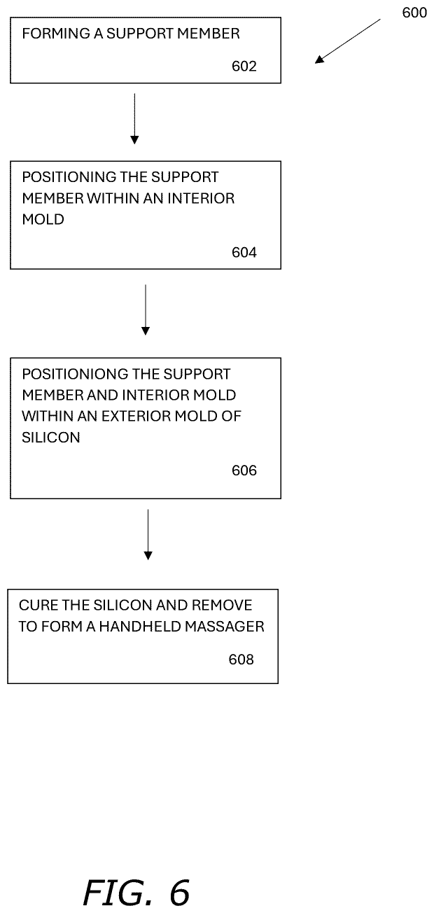

FIGS. 2-3 illustrate side perspective cutout views of another aspect of the handheld massager device of FIG. 1. FIG. 2 illustrates device 100 in a resting configuration while FIG. 3 illustrates device 100 in a massaging configuration. From the cutout views of FIGS. 2 and 3, it can be more clearly seen that device 100 is formed by an interior support or frame member 202 that is encased within or covered by (e.g., molded within) an exterior member 204. In some aspects, interior support or frame member 202 may be made from a metal such as aluminum or another similarly rigid material. Exterior member 204 may be made of compliant or flexible material that can be molded or otherwise bonded to interior support member 202. The compliant or flexible material forming exterior member 204 should be compliant enough to allow for the arms of handle 102 to be squeezed together while resilient enough to bias handle 102 to the resting position as shown. In this aspect, exterior member 204 may also be considered to provide a biasing function to handle 102 and/or be referred to herein as a biasing member. For example, exterior support member 204 may be made of a silicone material that is cured to the interior support member during a molding process that will be described in more detail in reference to FIG. 6.

Referring now in more detail to interior support or frame member 202, interior support or frame member 202 may include a first frame member 206 and a second frame member 208. Each of first and second frame members 206, 208 may include a portion that forms the device handle 102 and a portion that forms the device massaging portion 104. Representatively, first frame member 206 may be a single integrally formed structure including an elongated portion 206A that is relatively straight and a curved portion 206B. In some aspects, the elongated and curved portions 206A, 206B form a question mark or hook shaped frame member 206. Similarly, second frame member 208 may be a single integrally formed structure including an elongated portion 208A and a curved portion 208B that together form a question mark or hooked shaped frame member 208. In some aspects, notches, grooves or recessed regions 212, 214 may be formed in the edges of elongated portions 206A, 208A to help frame members 206, 208 grip the exterior support member 104. In other aspects, although elongated portions 206A, 208A are shown having substantially straight edges other than regions 212, 214, the edges may have multiple notches, curves or recessed regions of the same or different shapes/sizes such that the edges appear to have a wavy shape or have some portions that are curved while others are straight. First and second members 206 and 208 are then rotatably connected at their centers such that the curved portions 206B, 208B form the massaging portion 104 and the elongated portions 206A, 208A form the handle portion 102 of device 100. Representatively, the elongated portions 206A, 208A may form the previously discussed legs 102A, 102B, respectively, and the curved portions 206B, 208B may form the previously discussed arms 104B, 104A, respectively. In some aspects, first and second members 206 and 208 may be connected at their centers by a fastener member 210 such as a pin, bolt, screw or other connecting mechanism that allows the members 206, 208 to move (e.g., pivot or rotate) relative to one another. Representatively, movement of elongated member 206A of frame member 206 toward elongated member 208A of frame member 208 moves curved member 206B toward curved member 208B of frame member 208 as shown by the arrows in FIG. 3. Similarly, movement of elongated member 208A of frame member 208 toward elongated member 206A of frame member 206 moves curved member 208B toward curved member 206B of frame member 206 as shown by the arrows in FIG. 3. In this aspect, the spacing or distances (D1, D2, D3) between the legs of handle portion 102 and arms of massaging portion 104 decrease. Thus, squeezing the handle portion 102 moves the arms of massaging portion 104 closer together to the massaging position as shown in FIG. 3. In addition, as previously discussed, exterior member 204 provides a biasing force that biases handle portion 102 to the resting position as shown in FIG. 2. In this aspect, when the squeezing force is removed from handle portion 102, the legs of handle portion 102 move apart and back to the resting position shown in FIG. 2.

Referring now in more detail to exterior member 204, exterior member 204 may entirely encase, cover or surround interior support or frame member 202. For example, in some aspects, exterior member 204 may be molded over frame member 202. Exterior member 204 may be made of compliant or flexible material such as silicone that allows frame member 202 to move as previously discussed while also biasing frame member 202 to the resting position of FIG. 2. In some aspects, exterior member 204 may have a thickness (T) that is selected to provide the desired biasing force. For example, where a higher biasing force is desired, the thickness (T) may be increased to provide more resistance against movement of frame member 202. In other aspects where a lower biasing force is desired, the thickness (T) may be decreased to provide less resistance against movement of frame member 202. In some aspects, the thickness (T) of exterior member 204 may be relatively constant or the same around the entire frame member 202. In other aspects, the thickness (T) may be increased toward the distal end of the frame elongated portions 206A, 206B so that a wider and more stable bottom side of the handle legs is provided for improved upright stability. In still further aspects, materials of a particular density or durometer may be selected to achieve the desired biasing force and/or feel of the device. Representatively, silicone has a particular density or durometer that is particularly desirable as the exterior member 204 as it has the desired feel and provides the desired biasing force. In particular, the higher the durometer, the harder the surface will feel and the higher the biasing force. In other aspects, to achieve a harder or softer feel of the device to the touch, or the biasing force to the rested position, materials of different densities/durometers may be selected. In still further aspects, in addition to providing resistance or a biasing force, exterior member 204 also provides a more rounded and/or smooth massaging surface to device 100.

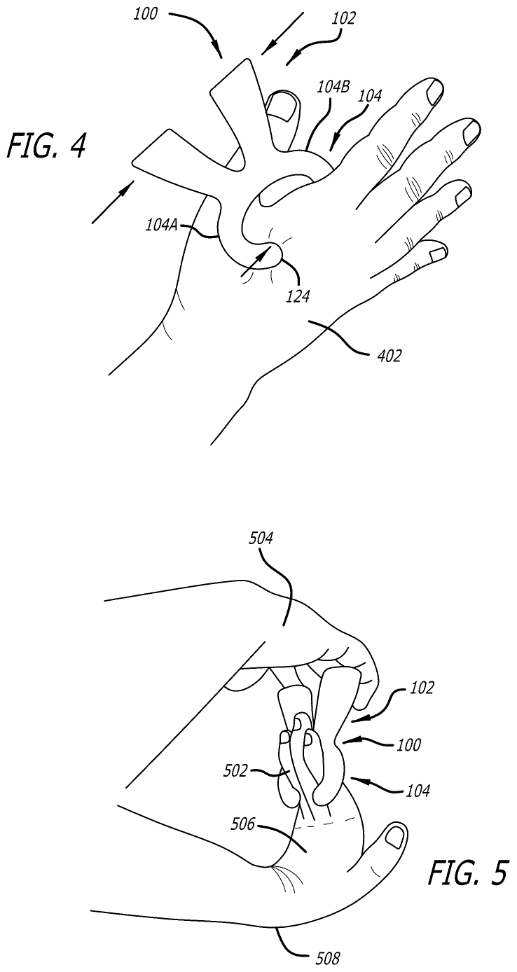

FIG. 4 illustrates a side perspective view of another aspect of the handheld massager device of FIG. 1 during operation. As can be seen from FIG. 4, during one representative massaging operation, the user's hand 402 is positioned within massager portion 104 of device 100. The distal end 124 of the massager arm 104A of massager portion 104 may be aligned with a pressure point on the hand for maximum effectiveness. For example, distal end 124 may be aligned with the hand valley point found in the firm skin between the thumb and index finger. Once in position, the user may squeeze handle portion 102 as shown by the arrows, which in turn causes distal ends 124, 126 to move toward one another to apply pressure and/or massage the hand 402 at the desired pressure point.

FIG. 5 illustrates a perspective view of another aspect of a handheld massager device of FIG. 1 during use. As can be seen from FIG. 5, during one representative massaging operation, the user's fingers 502 are positioned between the arms 104A, 104B of massager portion 104 of device 100. The user's other hand 504 holds the handle portion 102 from the opposite side and applies a pressure to stretch the soft tissue of the fingers 502, hand 506 and wrist 508.

FIG. 6 illustrates a block diagram of one exemplary process for manufacturing a handheld massager device. Representatively, in some aspects, process 600 may include forming support member (e.g., support member 202) at operation 602. The support member may be formed by cutting and milling two pieces of aluminum into the question mark like shaped members 206, 208 discussed in reference to FIGS. 2-3. In addition, in some aspects, small cuts may be made in the elongated portions of the support member to help grip the silicone and prevent the support member from moving within the exterior silicone member. A hole is then drilled through the centers of each of the members 206, 208 and a pin, screw or other fastener is inserted through the hole to hold members 206, 208 together to form the support member. In some aspects, a small amount of lubricant, such as grease, may be applied to the joint to allow for smooth movement of the device 100. Next, at operation 604, the support member is positioned within an interior mold including cured silicone. The interior mold is a smaller mold designed to hold the support member in place. At operation 606, the support member and interior mold are then placed within an exterior mold of silicone. The exterior mold is a larger mold having the outward shape of the device 100. At operation 608, the silicone is then cured resulting in the formation of a handheld massager having a silicone exterior and aluminum interior support member as previously discussed. It should further be understood that while the specific materials of aluminum and silicone are discussed, other similar materials may be used to form the device 100 as described in process 600.

In addition, it is contemplated that while exemplary uses of massager device 100 described herein relate to massaging tissue or body parts, device 100 may be used for other applications. For example, a user may squeeze the legs of the handle to build hand strength and improve blood flow throughout their extremities, and further supporting their health. A variety of other applications across acupressure, strength, dexterity and blood flow exercises are contemplated. In addition, device 100 provides the ability to regulate pressure applied to the massaged tissue and may be used on any body part including the fingers, wrists, arms, feet, toes, and the like.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting. In addition, to aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A handheld massager comprising:
a massager portion having a first arm and a second arm that curve toward one another and terminate at distal ends configured to be moved relative to one another to massage a tissue; and
a handle portion coupled to the massager portion, the handle portion having a first leg and a second leg configured to be moved relative to one another to move the distal ends.

2. The massager of claim 1 wherein the first arm and the second arm further comprise proximal ends that curve inwardly toward one another to form a c-shaped massager portion.

3. The massager of claim 2 wherein the proximal ends are coupled to the handle portion.

4. The massager of claim 1 wherein the distal ends are separated by a gap for receiving the tissue.

5. The massager of claim 1 wherein the distal ends have a substantially round shape.

6. The massager of claim 1 wherein the first leg and the second leg have proximal ends coupled to the massager portion and distal ends that are wider than the proximal ends.

7. The massager of claim 5 wherein the distal ends are flat and coplanar such that they are operable to support the massager in an upright position.

8. The massager of claim 1 wherein a movement of the first leg and the second leg toward one another causes the distal ends to move toward one another and massage the tissue.

9. The massager of claim 1 wherein the first leg and the second leg are biased away from one another by a biasing material coupled to a joint between the first leg and the second leg.

10. The massager of claim 1 wherein a portion of the first arm is integrally formed with a portion of the first leg and a portion of the second arm is integrally formed with a portion of the second leg.

11. The massager of claim 1 wherein an interior support member forms the first arm, the second arm, the first leg and the second leg, and the interior support member is molded within a silicone outer member.

12. A method of manufacturing a handheld massager comprising:
providing a support member having a first member defining a first curved portion and a first elongated portion, a second member defining a second curved portion and a second elongated portion, and a joint movably connecting the first member to the second member; and
molding a compliant material over the support member to form a handheld massager.

13. The method of claim 12 wherein providing the support member comprises milling the first member and the second member from a piece of aluminum.

14. The method of claim 13 wherein the first member and the second member are connected together by a fastener to form the joint that allows the first member and the second member to move relative to one another.

15. The method of claim 14 further comprising applying a lubricant to the joint.

16. The method of claim 12 wherein the first elongated portion or the second elongated portion comprises a recessed region dimensioned to grip the compliant material.

17. The method of claim 12 wherein molding comprises positioning the support member within an interior mold of cured compliant material.

18. The method of claim 17 wherein molding further comprises positioning the support member and interior mold within an exterior mold of the compliant material.

19. The method of claim 17 further comprising curing the compliant material to form the massager.

20. The method of claim 12 wherein the compliant material comprises a silicone material.
